(19) United States
(12) Patent Application Publication
(10) Pub. No.: US 2026/0353176 A1
(43) Pub. Date: Nov. 5, 2026

(54) SYSTEMS AND METHODS FOR INFORMATION TRANSFER FOR RELAY SYSTEMS

(71) Applicant: ZTE CORPORATION, Shenzhen (CN)

(72) Inventors: Ying HUANG, Shenzhen (CN); Lin CHEN, Shenzhen (CN); Tao QI, Shenzhen (CN)

(73) Assignee: ZTE CORPORATION, Shenzhen (CN)

(21) Appl. No.: 19/718,163

(22) Filed: Jun. 24, 2026

Related U.S. Application Data
(63) Continuation of application No. PCT/CN2023/141591, filed on Dec. 25, 2023.

(51) Int. Cl. H04W 28/02

(52) U.S. Cl. CPC H04W 28/0268

(57) ABSTRACT

Presented are systems and methods for information transfer for relay systems. A network node of a wireless access and backhaul communication system can receive traffic mapping information. The network node can perform mapping of one or more packets of non-UP (user plane) traffic, using the traffic mapping information.

### CROSS-REFERENCE TO RELATED APPLICATION

This application claims the benefit of priority under 35 U.S.C. § 120 as a continuation of International Patent Application No. PCT/CN2023/141591, filed on Dec. 25, 2023, the disclosure of which is incorporated herein by reference in its entirety.

### TECHNICAL FIELD

The disclosure relates generally to wireless communications, including but not limited to systems and methods for information transfer for relay systems.

### BACKGROUND

Coverage is a fundamental aspect of cellular network deployments. Mobile operators rely on different types of network nodes to offer blanket coverage in their deployments. As a result, new types of network nodes have been considered to increase the flexibility of mobile operators for their network deployments. For example, certain systems or architecture introduce integrated access and backhaul (IAB), which may be enhanced in certain other systems, as a new type of network node not requiring a wired backhaul. Another type of network node is the RF repeater which simply amplify-and-forward any signal that they receive. RF repeaters have seen a wide range of deployments in 2G, 3G and 4G to supplement the coverage provided by regular full-stack cells.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A network node (e.g., wireless access and backhaul (WAB) node or WAB donor) of a wireless access and backhaul communication system can receive/acquire/obtain traffic mapping information. The network node can perform/initiate/execute mapping of one or more packets of non-user plane (UP) traffic, using the traffic mapping information.

In some implementations, non-UP traffic can comprise at least one of: next generation control plane interface (NG-C) traffic, Xn control plane interface (Xn-C) traffic, and/or operations, administration and maintenance (OAM) traffic. In some implementations, the traffic mapping information can be configured by or received from a session management function (SMF) or access management function (AMF).

In some implementations, the traffic mapping information can comprise at least one of: a quality of service (QoS) flow identifier (QFI), a protocol data unit (PDU) session identifier (ID), a non-UP traffic type, a priority, an evolved radio access bearer (E-RAB) ID, internet protocol (IP) related information, and/or a data radio bearer (DRB) ID. In some implementations, the non-UP traffic type can comprise at least one of: user equipment (UE) associated NG-C, non-UE-associated NG-C, UE-associated Xn-C, non-UE-associated Xn-C, non-UP traffic, and/or OAM traffic.

In some implementations, the IP related information can include at least one of: an IP address, a differentiated services codepoint (DSCP), and/or a flow label. In some implementations, the network node can perform mapping of at least one of: the one or more packets of non-UP traffic, to at least one of: one or more QoS flows, an E-RAB, and/or a DRB, using the traffic mapping information.

In some implementations, the network node can send donor node information via an Xn application protocol (XnAP) or RRC message. In some implementations, the network node may send/transmit/provide/forward donor node information via a next generation application protocol (NGAP) message. In some implementations, the donor node information can comprise at least one of: information of the network node, information of a child node of the network node, information of a parent node of the network node, and/or information of a donor node.

In some implementations, the network node may send network node information to a donor node and/or a WAB node. The network node can receive a response message comprising at least one of: a gNodeB (gNB) identifier (ID), a cell ID, an IP address, a cell radio network temporary identifier (C-RNTI), an information of a child WAB node, and/or an Xn application protocol (XnAP) ID, of the donor node or the WAB node, from the donor node or the WAB node.

In some implementations, the network node information can comprise at least one of: an IP address, a cell radio network temporary identifier (C-RNTI), a Xn application protocol (XnAP) identifier (ID), information of a child node, and/or information of a parent node. In some cases, the network node information can comprise at least one of: a gNB ID, a cell ID, an IP address, information of a child node, and/or information of a parent node, of the network node.

In some implementations, the network node can send at least one of parent node information and/or child node information, to a donor node and/or a WAB node. The network node may receive topology information comprising at least one of: an IP address, and/or a next hop identifier (ID) from the donor node and/or the WAB node. In some implementations, the next hop ID can comprise at least one of: a gNodeB (gNB) identifier (ID), the IP address, a cell radio network temporary identifier (C-RNTI), and/or an Xn application protocol (XnAP) ID, of at least one of a parent node and/or a child node of the WAB node, and/or the donor node.

At least one aspect is directed to a system, method, apparatus, or a computer-readable medium. A core network function (e.g., access management function (AMF), session management function (SMF), etc.) may send/provide/communicate/transmit traffic mapping information to a network node of a wireless access and backhaul communication system. The one or more packets of control plane (CP) traffic can be mapped by the network node using the traffic mapping information.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example wireless access and backhaul architecture, in accordance with some embodiments of the present disclosure; and

FIG. 4 illustrates a flow diagram of an example method for information transfer for relay systems, in accordance with some embodiments of the present disclosure.

### DETAILED DESCRIPTION

### 1. Mobile Communication Technology and Environment

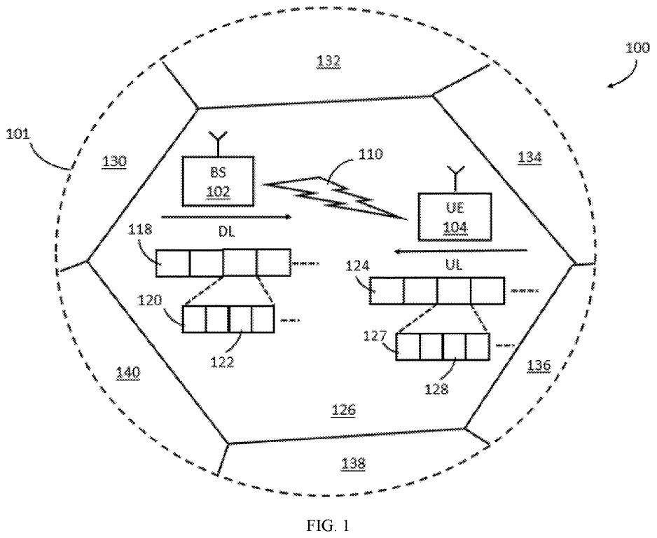

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

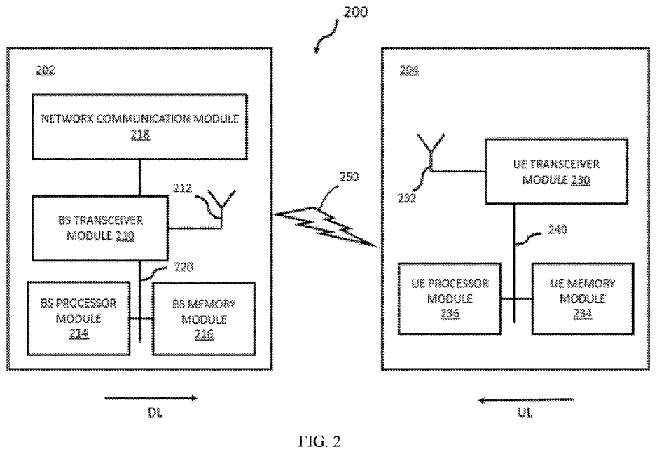

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems And Methods for Information Transfer for Relay Systems

In certain systems, a wireless access and backhaul architecture (e.g., integrated access and backhaul (IAB) or wireless access and backhaul (WAB)) can be provided to support or allow for wireless access and backhauling via/through new radio (NR) (e.g., NR technology or features). Supporting the wireless access and backhauling can allow/enable flexible and relatively dense deployment of NR cells, and reduce/minimize wireline transport infrastructure, for example.

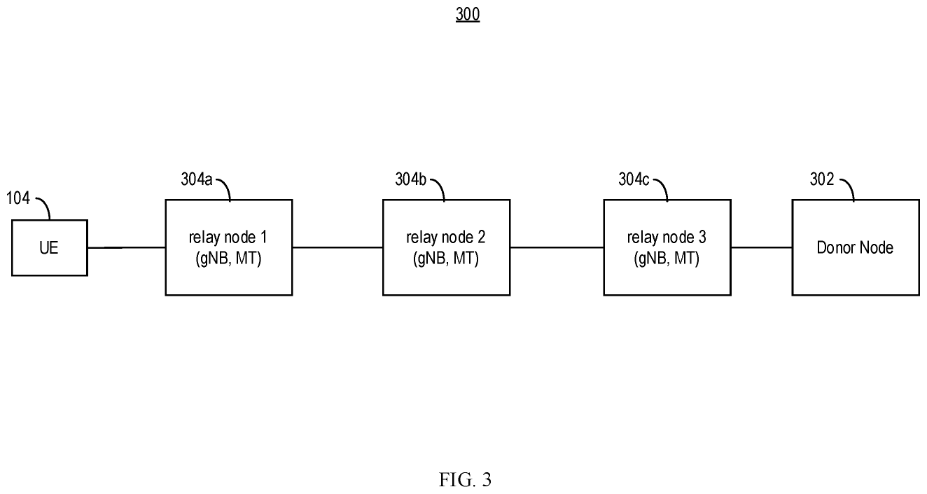

A relay node, such as an IAB node or WAB node, among other types of compatible nodes, can support access and backhauling via NR. The terminating node of NR backhauling on the network side can be referred to as a donor node. The donor node can represent a BS 102 (e.g., gNB, wireless communication node, or transmission and reception point (TRP)) with one or more functionalities to support or allow wireless access and backhaul. Backhauling can occur via a single hop or multiple hops. An example architecture of the wireless access and backhaul can be described in conjunction with but not limited to FIG. 3.

FIG. 3 illustrates an example wireless access and backhaul architecture 300, in accordance with some embodiments of the present disclosure. The exemplary wireless access and backhaul architecture 300 can include at least one UE 104, at least one donor node 302, and relay nodes 304a-c (e.g., sometimes referred to as relay node(s) 304). The exemplary wireless access and backhaul architecture 300 can include more or fewer components or devices, such as more or fewer relay nodes 304, not limited to three relay nodes 304, as described in conjunction with FIG. 3, for example. The donor node 302 can correspond to the BS 102. Although not explicitly shown, it should be understood that at least the donor node 302 can be in communication with other devices (e.g., network devices), such as a core network function (e.g., access management function (AMF), session management function (SMF), etc.).

The relay nodes 304a-c can be referred to as relay node 1, relay node 2, and relay node 3, respectively, for purposes of examples herein. The relay nodes 304 that are relatively closer to the donor node 302 can be the parent of the relay nodes 304 further from the donor node 302 (or closer to the UE 104), or vice versa in some arrangements. For example, the relay node 2 can be the parent node of relay node 1, e.g., relay node 1 can be the child node of relay node 2. The relay node 3 can be the parent node of relay node 2, e.g., relay node 2 can be the child node of relay node 3.

In various implementations, the relay node 304 can include, support, or be configured with gNB functionality (e.g., functionalities similar to the BS 102). For example, the gNB functionality can include at least one of but is not limited to a function to terminate the NR access interface to one or more UEs 104 and/or a function to terminate the Xn/next generation (NG) protocol to the donor node 302 and/or the core network function (e.g., AMF, SMF, etc.). The relay node 304 can include, support, or be configured with a subset of the UE functionality (e.g., sometimes referred to as MT). The UE functionality can include at least one of but is not limited to physical layer, layer-2, radio resource control (RRC), and/or non access stratum (NAS) functionality to connect to another relay node 304, the donor node 302, and/or to the core network, among other functionalities, for example. In certain scenarios, it may be challenging to perform mapping of non-UP traffic (e.g., control plane (CP) traffic, etc.) for the one or more relay nodes 304 within the wireless access and backhaul architecture 300. The systems and methods of the technical solution discussed herein can provide features or configurations for supporting non-user plane (UP) traffic mapping for the (e.g., wireless) relay nodes 304.

### Example Implementation 1

In some implementations, if a WAB node (e.g., the relay node 304) includes the gNB functionality, the traffic (e.g., packets or signals) may be transferred/sent/communicated/forwarded via one or multiple backhaul links between the WAB node and the donor node 302 (e.g., the BS 102 or gNB). The traffic can include at least one of user plane (UP) traffic, control plane (CP) traffic (e.g., Xn control plane interface (Xn-C) traffic and/or next generation control plane interface (NG-C) traffic), and/or operations, administration and maintenance (OAM) traffic, among other types of traffic. For example, the traffic can be routed/transferred via one or multiple protocol data unit (PDU) sessions to the user plane function (UPF) of the MT in the WAB donor. Subsequently, the UPF of the MT (e.g., in the WAB donor) can send/forward/transmit the traffic to the UPF, AMF, and/or other WAB nodes or other WAB donors via internet protocol (IP) routing or other routing mechanisms for routing packets to or from one or more devices.

In certain systems, quality of service (QoS) flow may not be utilized/used for transferring the control plane signaling (e.g., packets or traffic). Further, in such systems, there may not be QoS Flow level QoS parameters configured for non-UP traffic (e.g., CP traffic, etc.) at NG RAN node. The systems and methods of the technical solution can provide features for configuring the traffic mapping for CP traffic (or other non-UP traffic) at the NG-RAN node (e.g., the gNB in the relay node 304) and/or the donor node 302. In some implementations, the donor node 302 can include the functionality of the NG-RAN node and/or UPF. In some cases, the NG-RAN node may be a part of the donor node 302.

To configure the traffic mapping for the CP traffic, the donor node 302 (e.g., the MT's UPF located in the donor node 302) can receive/obtain/acquire packets from the AMF of the UE 104 in the core network and/or from other NG-RAN nodes or OAMs. Then, the donor node 302 can map the received IP packets to the QoS flows according to or based on one or more packet detection rules (PDRs). For instance, the PDR can include classifying incoming data packets by the UPF based on packet filter sets of the downlink (DL) PDRs. The PDR can include other criteria or parameters. The UPF can send/transmit the PDUs of the PDU session in a tunnel between a core network (e.g., 5GC) and the (radio) access network ((R)AN). The UPF may include at least a QoS flow identifier (QFI) in the next generation application protocol (NGAP) general packet radio service (GPRS) tunneling protocol-user plane (GTP-U) header.

For example, for the (e.g., IP) packets (e.g., Xn-C packets) generated by the donor node 302, the donor node 302 can send/deliver the packets to its co-located MT's UPF. In response to receiving the packets, the MT's UPF can map the IP packets generated by the donor node 302 to QoS flows as discussed herein.

Next, in some implementations, the donor node 302 (e.g., a first network node or WAB) can determine the next hop for the packets. The next hop for the packets can refer to the next relay node 304 or network node for the donor node 302 to transmit the packets. The determination of the next hop can be described in conjunction with but not limited to exemplary implementations 4 and/or 5, for example. For non-UP (e.g., CP) traffic, traffic mapping information used for non-UP traffic can be configured by the core network function (e.g., SMF and/or AMF) at NG-RAN node (e.g., the gNB portion of the WAB node/WAB donor). The non-UP traffic can include at least one of NG-C signaling/traffic, Xn-C traffic, and/or OAM traffic, among others. The donor node 302 can receive/obtain the traffic mapping information from at least one of the core network functions (e.g., SMF and/or AMF). The traffic mapping information can include at least one of QoS flow identifier (QFI), PDU session ID, non-UP traffic type, priority, evolved radio access bearer (E-RAB) ID, etc. The non-UP traffic type can include at least one of but not limited to UE-associated NG-C, non-UE-associated NG-C, UE-associated Xn-C, non-UE-associated Xn-C, non-UP traffic, and/or OAM traffic, to name a few.

Subsequently, the NG-RAN node (e.g., the gNB portion of the WAB node/WAB donor) can perform/execute/initiate mapping for the PDUs (e.g., packets from QoS Flows to data radio bearer DRB) based on, according to, or using the traffic mapping information configured by the core network function (e.g., AMF and/or SMF, etc.).

### Example Implementation 2

In certain systems, the QoS flow may not be used for transferring the control plane signaling (e.g., packets or traffic). Further, in such systems, there may not be QoS Flow level QoS parameters configured for non-UP traffic (e.g., CP traffic, etc.) at NG RAN node (e.g., the network node, such as at least one of the relay nodes 304). The systems and methods of the technical solution can provide features for configuring the traffic mapping for CP traffic (or other non-UP traffics) at the NG-RAN node and/or the donor node 302. In some aspects, the systems and methods of exemplary implementation 2 can be described in conjunction with but not limited to the exemplary implementation 1.

In various implementations, the mapping information can be configured at the relay node 304 (e.g., IAB node and/or WAB node) and/or the donor node 302. Although the WAB node may be provided as an example relay node 304, it should be understood that other relay nodes 304 can be provided herein, not limited to the WAB node. Similarly, although the AMD or the SMF is provided as an example core network function, it should be understood that other core network functions not limited to the AMF or the SMF can be provided herein, for example.

The WAB node and/or the donor node can obtain/receive mapping configuration (e.g., traffic mapping information) from the AMF and/or SMF (e.g., the core network function). The mapping configuration can include at least one of but is not limited to IP related information, QFI, PDU session ID, E-RAB ID, DRB ID, etc. The IP related information can include at least one of but not limited to an IP address, a differentiated services codepoint (DSCP), and/or a flow label. For example, the mapping information may be used to perform a mapping from IP, DSCP, and/or flow label to the QFI, from QFI to E-RAB and/or DRB, and/or from the IP, DSCP, and/or flow label to E-RAB and/or DRB, among others.

After obtaining the mapping information, the donor node 302 can obtain one or more packets from the AMF of the UE 104 or other NG-RAN nodes (e.g., the gNB functionality of at least one of the relay nodes 304). The donor node 302 can determine the next hop (e.g., which of the WAB nodes) to forward the packets (or to receive the packets from the donor node 302). The determination of the next hop can be described in conjunction with but not limited to exemplary implementation 4 and/or 5, for example. Responsive to determining the next hop, the donor node 302 can map at least one of one or more IP packets to at least one of the QoS flows, E-RAB, and/or DRB, etc., of the determined WAB node (e.g., the next hop) according to the configured mapping configuration (e.g., traffic mapping information).

For example, for the packets (e.g., Xn-C packets) generated by the donor node 302, the donor node 302 can determine the next hop for receiving the packets. In some cases, the next hop may be determined as the relay node 3, for example. In this case, in response to the determination, the donor node 302 can map the IP packets to QoS flows, E-RAB, DRB, etc., of the relay node 3 according to the configured mapping configuration.

### Example Implementation 3

In certain systems, the core network function (e.g., AMF and/or SMF) may be connected to multiple donor nodes 302 simultaneously. In such systems, it may be challenging for the core network function to determine or identify which donor node 302 is connected to a particular relay node 304 (e.g., the desired WAB node). The systems and methods of the technical solution discussed herein can provide features or techniques for determining or identifying the donor node 302 that is connected to the desired relay node 304, such that the core network function can send the NG signaling (or other types of signalings) for the relay node 304 to the corresponding donor node 302. In some configurations, the systems and methods can perform these features or techniques for the exemplary implementations 1 and/or 2, for example.

For example, the relay node 304 (e.g., the WAB node) can send/transmit/provide donor node information via a next generation application protocol (NGAP) message (e.g. NG setup request message) to the core network function (e.g., AMF). In some cases, the relay node 304 may send the donor node information via at least one of an Xn message and/or an RRC message (or other types of messages or signalings) to at least one of the donor node, the parent node, the child node, the neighboring WAB node, and/or the neighboring donor node, among others. The donor node information can include at least one of but not limited to information of the network node (e.g., relay node 304) including the WAB node, information of the donor node 302. The information of the relay node 304 and/or the donor node 302 can include at least one of gNB ID, cell ID, IP address, etc.

In various configurations, the relay node 304 can communicate with the core network function (e.g., for sending the donor node information) via the corresponding donor node 302. For example, the relay node 304 can send the donor node information to the core network function via the donor node 302. In some configurations, the relay node 304 may send an indication to (or notify) the donor node 302 to send its information (e.g., the donor node information) to the core network function. The donor node 302 can be an intermediary device between the one or more relay nodes 304 and the core network function, for example. The core network function can store the donor node information received/obtained from the relay node 304 or the donor node 302. The core network function can determine the donor node 302 associated with the desired relay node 304 according to the donor node information, e.g., when sending NG signaling for the relay node 304 (e.g., IAB node and/or WAB node).

### Example Implementation 4

The systems and methods of the technical solution can provide features or operations discussed herein for the donor node 302 and/or the relay node 304 (e.g., IAB node or WAB node) to determine the next hop (e.g., another relay node 304 or donor node 302) for sending or to receive the DL packets, such as for a one-hop case/scenario. The systems and methods of the technical solution can provide features or operations for the donor node 302 and/or the relay node 304 to identify or determine the (co-)location of the MT and/or gNB parts (e.g., to perform UE functionalities or gNB functionalities, respectively) of the relay node 304.

### Example Configuration 1 of the Example Implementation 4

In various configurations, the relay node 304 can send its information (e.g., the relay node information, such as at least one of but not limited to IP address, C-RNTI, XnAP ID, parent WAB node information, etc.) in the XnAP (e.g., Xn setup request) message (or other signalings/messages) to the donor node 302 and/or one or more other relay nodes 304. The relay node 304 can send other information, such as information related to the child WAB node, etc., to the donor node 302 and/or the one or more other relay nodes 304. The parent relay node information may include at least one of gNB ID, cell ID, and/or IP address, among others.

Subsequently, the donor node 302 or the one or more other relay nodes 304 may send its information in the XnAP message (e.g., response message) to the relay node 304. The information from the donor node 302 or the one or more other relay nodes 304 may include at least one of gNB ID, cell ID, IP address, C-RNTI, XnAP ID, and/or child WAB node information, or other types of information.

### Example Configuration 2 of the Example Implementation 4

In various configurations, the relay node 304 can send its information (e.g., relay node information) in the RRC message to its parent relay node or the donor node 302. The information can include at least one of but not limited to gNB ID, cell ID, IP address, XnAP ID and/or the parent WAB node information.

The donor node 302 and/or the parent relay node can send its information in a response message to the relay node 304, such as in response to receiving the information. In this case, the information sent by the donor node 302 and/or the parent relay node may include at least one of: gNB ID, cell ID, IP address, C-RNTI, XnAP ID, child WAB node information, etc.

### Example Implementation 5

The systems and methods of the technical solution can provide features or operations discussed herein for the donor node 302 and/or the relay node 304 (e.g., IAB node or WAB node) to determine the next hop (e.g., another relay node 304 or donor node 302) for sending or to receive the DL packets, such as for a multi-hop case/scenario. The systems and methods of the technical solution can provide features or operations for the donor node 302 and/or the relay node 304 to identify or determine the (co-)location of the MT and/or gNB parts of the relay node 304. The features or operations of the exemplary implementation 5 may be described additionally or alternatively to the exemplary implementation 4, for example.

In some configurations, the relay node 304 (e.g., WAB node) may send the parent node information to the donor node 302 and/or the child relay node via RRC signaling, Xn signaling (e.g., XnAP message), or other types of signalings. For example, in conjunction with the example architecture 300, relay node 2 may send information related to relay node 3 to at least one of the donor node 302 and/or relay node 1, which is the child relay node of relay node 2.

In some arrangements, the relay node 304 may send the child node information to the parent relay node and/or the donor node 302 and/or send the parent node information to the child relay node and/or the donor node 302. For example, in conjunction with the example architecture 300, relay node 2 may send information related to relay node 3 to at least one of the donor node 302 and/or relay node 1 or send information related to relay node 1 to at least one of the donor node 302 and/or relay node 3. The information of the parent relay node and/or the child relay node can include at least one of gNB ID, cell ID, IP address, C-RNTI, XnAP ID, etc.

According to the child node information or the parent node information of the relay node 304, the donor node 302 can generate/construct topology information, and/or send the topology information to the relay node 304 via RRC signaling, Xn signaling, or other types of signalings. For example, the topology information can include at least one of IP address, the next hop ID, etc. The next hop ID can include at least one of gNodeB (gNB) ID, IP address, C-RNTI, and/or XnAP ID, among other information, of at least one of the parent node or the child node of the relay node 304 or the donor node 302, for example. In response to receiving the topology information, the donor node 302 and/or the relay node 304 can determine the next hop for sending the traffics based on the topology information.

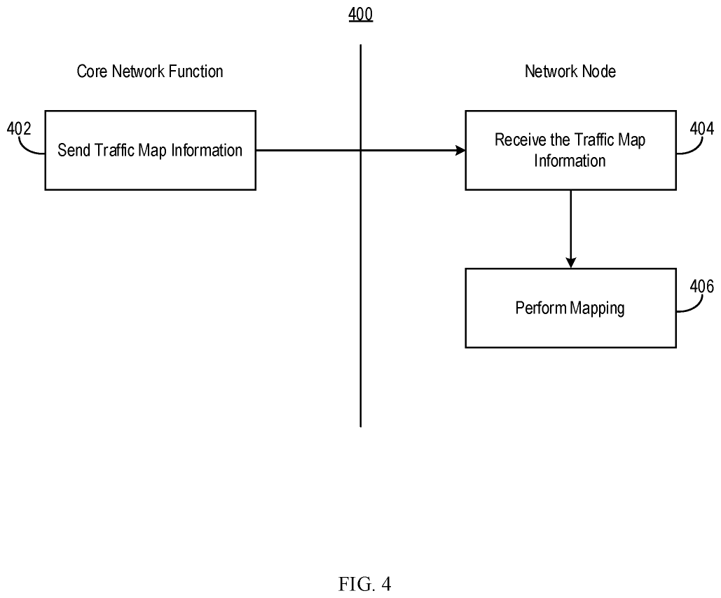

FIG. 4 is a flow diagram illustrating an example method 400 for information transfer for relay systems. The method 400 may be implemented using any one or more of the components and devices detailed herein in conjunction with FIG. 1-3. In brief overview, the method 400 can be performed by one or more network devices, such as one or more wireless communication devices (e.g., UE(s) 104), at least one donor node (e.g., wireless communication node, BS, gNB, or TRP), at least one network node (e.g., IAB node/donor, WAB node/donor, etc.), and/or at least one core network function (e.g., SMF, AMF, etc.), etc., in some embodiments. Additional, fewer, or different operations may be performed in the method 400 depending on the embodiment. At least one aspect of the operations is directed to a system, method, apparatus, or a computer-readable medium.

At operation 402, a core network function (e.g., SMF and/or AMF) may send/transmit/provide/communicate traffic mapping information to a network node (e.g., WAB node or WAB donor) of a wireless access and backhaul communication system. The wireless access and backhaul communication system may refer to or be described in conjunction with but not limited to the architecture 300 of FIG. 3, for example. At operation 404, the network node can receive/obtain/acquire the traffic mapping information from the core network function. The network node may include or correspond to a WAB node or WAB donor, for example. The network node may be referred to as a first network node. The network node may be in communication with at least one of one or more other network nodes, at least one wireless communication device, or at least one donor node.

At operation 406, the network node can perform mapping of one or more packets of non-user plane (UP) traffic (e.g., PDUs from QoS flows to DRB) according to or using the traffic mapping information. The packets may include or be referred to as IP packets. Performing the mapping can allow/enable the non-UP downlink (DL) traffic delivery between the network node and other network element, e.g., AMF, NG-RAN node, etc., and/or allow for configuring the parameters for the bearer (e.g., DRB) used for non-UP traffic.

In some implementations, non-UP traffic can include at least one of: next generation control plane interface (NG-C) traffic, Xn control plane interface (Xn-C) traffic, and/or operations, administration and maintenance (OAM) traffic, among others. In some implementations, such as for non-UP (e.g., CP) traffic (e.g. NG-C signaling, Xn-C signaling, and/or OAM signaling), the traffic mapping information can be configured by or received from a session management function (SMF) or access management function (AMF).

In some implementations, the traffic mapping information can include at least one of, but not limited to: a quality of service (QoS) flow identifier (QFI), a protocol data unit (PDU) session identifier (ID), a non-UP traffic type, a priority, an evolved radio access bearer (E-RAB) ID, internet protocol (IP) related information, and/or a data radio bearer (DRB) ID. In some implementations, the non-UP traffic type can include at least one of: user equipment (UE) associated NG-C, non-UE-associated NG-C, UE-associated Xn-C, non-UE-associated Xn-C, non-UP traffic, and/or OAM traffic. The IP related information may include at least one of: an IP address, a differentiated services codepoint (DSCP), and/or a flow label, as some examples.

In some implementations, the network node can perform mapping of at least one of: the one or more packets of non-UP traffic, to at least one of: one or more QoS flows, an E-RAB, and/or a DRB, using the traffic mapping information. In some implementations, the network node can send donor node information via at least one of an Xn application protocol (XnAP) (e.g., Xn message) and/or RRC message, among other types of messages or signalings, to the donor node, the parent node, the child node, the neighboring WAB node, and/or the neighboring donor node, for example. In some implementations, the network node may send donor node information via a next generation application protocol (NGAP) message. Sending the donor node information can allow/enable the core network function (e.g., AMF, SMF, etc.) to identify the donor node that the network node (e.g., WAB node/donor) is connected to, such that the core network function can send the NG signaling (or other types of signalings) for the network node to the corresponding donor node (e.g., for forwarding). In some implementations, the donor node information may include at least one of but not limited to: information of the network node, information of a child node of the network node, information of a parent node of the network node, and/or information of a donor node.

In some implementations, the network node can send/provide information to a donor node and/or a WAB node (e.g., a second network node). The network node may receive a response message from the donor node or the WAB node, for instance, as a reply to the provided information. The response message can include at least one of but not limited to: a gNodeB (gNB) identifier (ID), a cell ID, an IP address, a cell radio network temporary identifier (C-RNTI), an information of a child WAB node, and/or an Xn application protocol (XnAP) ID, of the donor node or the WAB node.

In some implementations, the network node information may include at least one of: an IP address, a cell radio network temporary identifier (C-RNTI), a Xn application protocol (XnAP) identifier (ID), information of a child node, and/or information of a parent node. In some cases, the network node information may include at least one of: a gNB ID, a cell ID, an IP address, information of a child node, and/or information of a parent node, of the network node. The network node information may include other information not limited to those discussed herein.

In some implementations, the network node can send at least one of parent node information and/or child node information, to a donor node or a WAB node (e.g., child node, parent node, or neighbor node). In this case, the WAB node may be a second network node. For example, the network node can send the parent node information if the WAB node is a child node (e.g., child network node or child relay node) of the network node. In another example, the network node can send the child node information if the WAB node is a parent node (e.g., parent network node or parent relay node) of the network node.

The network node can receive/obtain the topology information from the donor node or the WAB node, for instance, as a response to sending the at least one of the parent node information and/or child node information. The topology information can include at least one of but not limited to: an IP address and/or a next hop identifier (ID). In some implementations, the next hop ID can include at least one of but not limited to: a gNodeB (gNB) identifier (ID), the IP address, a cell radio network temporary identifier (C-RNTI), and/or an Xn application protocol (XnAP) ID, of at least one of a parent node and/or a child node of the WAB node, and/or the donor node.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method, comprising:
receiving, by a network node of a wireless access and backhaul (WAB) communication system, traffic mapping information from a core network function; and
performing, by the network node, mapping of one or more packets of non-user plane (UP) traffic, using the traffic mapping information.

2. The method of claim 1, wherein non-UP traffic comprises at least one of: next generation control plane interface (NG-C) traffic, Xn control plane interface (Xn-C) traffic, or operations, administration and maintenance (OAM) traffic.

3. The method of claim 1, wherein the traffic mapping information is configured by or received from a session management function (SMF) or access management function (AMF).

4. The method of claim 1, wherein the traffic mapping information comprises at least one of: a quality of service (QoS) flow identifier (QFI), a protocol data unit (PDU) session identifier (ID), a non-UP traffic type, a priority, an evolved radio access bearer (E-RAB) ID, internet protocol (IP) related information, or a data radio bearer (DRB) ID.

5. The method of claim 4, wherein the non-UP traffic type comprises at least one of: user equipment (UE) associated next generation control plane interface (NG-C), non-UE-associated NG-C, UE-associated Xn control plane interface (Xn-C), non-UE-associated Xn-C, non-UP traffic, or operations, administration and maintenance (OAM) traffic.

6. The method of claim 4, wherein the IP related information includes at least one of: an IP address, a differentiated services codepoint (DSCP), or a flow label.

7. The method of claim 1, comprising:
performing, by the network node using the traffic mapping information, mapping of at least one of: the one or more packets of non-UP traffic, to at least one of: one or more QoS flows, an evolved radio access bearer (E-RAB), or a data radio bearer (DRB).

8. The method of claim 1, comprising:
sending, by the network node, donor node information via an Xn application protocol (XnAP) or radio resource control (RRC) message.

9. The method of claim 1, comprising:
sending, by the network node, donor node information via a next generation application protocol (NGAP) message.

10. The method of claim 9, wherein the donor node information comprises at least one of:
information of the network node, information of a child node of the network node, information of a parent node of the network node, or information of a donor node.

11. The method of claim 1, comprising:
sending, by the network node, network node information to a donor node or a WAB node; and
receiving, by the network node from the donor node or the WAB node, a response message comprising at least one of: a gNodeB (gNB) identifier (ID), a cell ID, an internet protocol (IP) address, a cell radio network temporary identifier (C-RNTI), information of a child WAB node, or an Xn application protocol (XnAP) ID, of the donor node or the WAB node.

12. The method of claim 11, wherein:
the network node information comprises at least one of: an IP address, a cell radio network temporary identifier (C-RNTI), an Xn application protocol (XnAP) identifier (ID), information of a child node, or information of a parent node, associated with the network node; or
the network node information comprises at least one of: a gNB ID, a cell ID, an IP address, information of a child node, or information of a parent node, of the network node.

13. The method of claim 1, comprising:
sending, by the network node, at least one of parent node information or child node information, to a donor node or a WAB node; and
receiving, by the network node from the donor node or the WAB node, topology information comprising at least one of: an internet protocol (IP) address, or a next hop identifier (ID).

14. The method of claim 13, wherein the next hop ID comprises at least one of: a gNodeB (gNB) identifier (ID), the IP address, a cell radio network temporary identifier (C-RNTI), or an Xn application protocol (XnAP) ID, of at least one of a parent node or a child node of the WAB node, or the donor node.

15. A method, comprising:
sending, by a core network function to a network node of a wireless access and backhaul (WAB) communication system, traffic mapping information,
wherein one or more packets of control plane (CP) traffic is mapped by the network node using the traffic mapping information.

16. A core network function, comprising:
at least one processor configured to:
send, via a transmitter to a network node of a wireless access and backhaul (WAB) communication system, traffic mapping information,
wherein one or more packets of control plane (CP) traffic is mapped by the network node using the traffic mapping information.

17. A network node of a wireless access and backhaul (WAB) communication system, comprising:
at least one processor configured to:
receive, via a receiver, traffic mapping information from a core network function; and
perform mapping of one or more packets of non-user plane (UP) traffic, using the traffic mapping information.

18. The method of claim 17, wherein non-UP traffic comprises at least one of: next generation control plane interface (NG-C) traffic, Xn control plane interface (Xn-C) traffic, or operations, administration and maintenance (OAM) traffic.

19. The method of claim 17, wherein the traffic mapping information is configured by or received from a session management function (SMF) or access management function (AMF).

20. The method of claim 18, wherein the traffic mapping information comprises at least one of: a quality of service (QoS) flow identifier (QFI), a protocol data unit (PDU) session identifier (ID), a non-UP traffic type, a priority, an evolved radio access bearer (E-RAB) ID, internet protocol (IP) related information, or a data radio bearer (DRB) ID.
